(19) United States
(12) Patent Application Publication
(10) Pub. No.: US 2017/0101343 A1
(43) Pub. Date: Apr. 13, 2017

(54) FIRE-PROOF MAGNESIUM OXYSULFATE PLATE AND METHODS OF MAKING SAME

(71) Applicant: Vantem Composite Technologies, LLC, Boston, MA (US)

(72) Inventor: Chun Ke Zheng, Suxi (CN)

(21) Appl. No.: 15/292,850

(22) Filed: Oct. 13, 2016

Related U.S. Application Data
(60) Provisional application No. 62/240,672, filed on Oct. 13, 2015.

(51) Int. Cl. C04B 28/32; B28B 1/52

(52) U.S. Cl. CPC C04B 28/32; B28B 1/52; C04B 2111/28

(57) ABSTRACT

Techniques are disclosed for providing a high-strength, water-resistant, fire-proof magnesium oxysulfate (MOS) plate. In accordance with some embodiments, the MOS plate may include one or more fibrous layers disposed within a sizing agent. The sizing agent may include backing materials, intermediate materials, and surface materials components. In some embodiments, the sizing agent may be homogeneous, such that its backing, intermediate, and surface materials components are all of the same material composition. In other embodiments, the sizing agent may be heterogeneous, such that one or more of its backing, intermediate, and surface materials components differ in material composition relative to other component(s). In accordance with some embodiments, a MOS plate provided via the disclosed techniques may be utilized, for example, as a cementitious skin of a structural insulated panel (SIP).

### CROSS-REFERENCE TO RELATED APPLICATIONS

This patent application claims the benefit of U.S. Provisional Patent Application No. 62/240,672, titled “A High Strength Water-Resistant Magnesium Oxysulfate Fire-Proof Plate and Its Preparation Method,” filed on Oct. 13, 2015. In addition, this patent application is related to U.S. patent application Ser. No. 14/950,274, titled “Finish-Ready Structural Insulating Panels,” filed on Nov. 24, 2015. Each of these patent applications is herein incorporated by reference in its entirety.

### FIELD OF THE DISCLOSURE

The present disclosure relates to fire-proof plates and, more particularly, to a high-strength, water-resistant magnesium oxysulfate fire-proof plate and its method of preparation.

### BACKGROUND

Structural insulated panels (SIPs) are a composite building material that typically consists of an insulating polystyrene or polyurethane foam core sandwiched between two layers of oriented strand board (OSB), sheet metal, plywood, cement, or magnesium oxide (MgO) board. SIPs are typically utilized in residential and light commercial construction. SIPs can be fabricated to fit nearly any building design and can provide a strong, energy-efficient, and cost-effective alternative to traditional lumber construction.

### SUMMARY

The subject matter of this patent application may involve, in some cases, interrelated products, alternative solutions to a particular problem, and/or a plurality of different uses of a single system or article.

One example embodiment provides a magnesium oxysulfate plate including: a sizing agent; a first fibrous layer disposed at a first location within the sizing agent; and a second fibrous layer disposed at a second location within the sizing agent, wherein the first location and the second location are not immediately adjacent one another. In some cases, the sizing agent includes: a backing materials component; an intermediate materials component adjacent to the backing materials component; and a surface materials component adjacent to the intermediate materials component. In some such instances, at least one of: the first fibrous layer is disposed between the backing materials component and the intermediate materials component; and the second fibrous layer is disposed between the intermediate materials component and the surface materials component. In some instances, the backing materials component, the intermediate materials component, and the surface materials component are each of the same material composition. In some cases, the backing materials component, the intermediate materials component, and the surface materials component each include: 240 portions of 25° Bé magnesium sulfate solution; 300 portions of 85% light calcined magnesia; 90 portions of coal ash; 60 portions of saw powder; 30 portions of lightweight perlite; 1 portion of tartrate; 1 portion of polycarboxylate superplasticizer; and 9 portions of styrene-butadiene emulsion. In some instances, the backing materials component, the intermediate materials component, and the surface materials component are each of different material composition. In some cases, at least one of: (1) the backing materials component includes: 80 portions of 25° Bé magnesium sulfate solution; 100 portions of 85% light calcined magnesia; 90 portions of coal ash; 10 portions of kaoline; 30 portions of lightweight perlite; 0.2 portions of tartrate; 0.3 portions of polycarboxylate superplasticizer; and 5 portions of styrene-butadiene emulsion; (2) the intermediate materials component includes: 240 portions of 25° Bé magnesium sulfate solution; 300 portions of 85% light calcined magnesia; 100 portions of coal ash; 60 portions of saw powder; 30 portions of lightweight perlite; 0.6 portions of tartrate; 1 portion of polycarboxylate superplasticizer; and 9 portions of styrene-butadiene emulsion; and (3) the surface materials component includes: 120 portions of 25° Bé magnesium sulfate solution; 150 portions of 85% light calcined magnesia; 50 portions of coal ash; 30 portions of saw powder; 0.3 portions of tartrate; 0.5 portions of polycarboxylate superplasticizer; and 5 portions of styrene-butadiene emulsion. In some other cases, at least one of: (1) the backing materials component includes: 80 portions of 25° Bé magnesium sulfate solution; 100 portions of 85% light calcined magnesia; 90 portions of calcium carbonate heavy; 10 portions of kaoline; 30 portions of lightweight perlite; 0.2 portions of tartrate; 0.3 portions of polycarboxylate superplasticizer; and 5 portions of styrene-butadiene emulsion; (2) the intermediate materials component includes: 240 portions of 25° Bé magnesium sulfate solution; 300 portions of 85% light calcined magnesia; 100 portions of calcium carbonate heavy; 60 portions of saw powder; 30 portions of lightweight perlite; 0.6 portions of tartrate; 1 portion of polycarboxylate superplasticizer; and 9 portions of styrene-butadiene emulsion; and (3) the surface materials component includes: 120 portions of 25° Bé magnesium sulfate solution; 150 portions of 85% light calcined magnesia; 50 portions of calcium carbonate heavy; 30 portions of saw powder; 0.3 portions of tartrate; 0.5 portions of polycarboxylate superplasticizer; and 5 portions of styrene-butadiene emulsion. In some instances, at least one of the backing materials component, the intermediate materials component, and the surface materials component includes: 80-240 portions of 23-28° Bé magnesium sulfate solution; 100-300 portions of 85% light calcined magnesia; 0.1-5 portions of tartrate; 2-10 portions of a styrene-butadiene emulsion; 0-100 portions of a heavyweight filler; 0-100 portions of a lightweight filler; and 0.1-5 portions of a water-reducing agent. In some cases, the sizing agent includes a heavyweight filler including at least one of coal ash, ground limestone, kaoline, dolomite dust, calcium carbonate heavy, quartz sand, and talcum powder. In some cases, the sizing agent includes a lightweight filler including at least one of plant fiber, lightweight perlite, lightweight vermiculite, and glass beads. In some cases, the sizing agent includes a water-reducing agent including at least one of a polycarboxylate superplasticizer and a naphthalene water reducer. In some instances, at least one of the first fibrous layer and the second fibrous layer includes at least one of fiberglass, C-glass, carbon fiber cloth, steel wire gauze, short fiber, steel fiber, and fiber mesh cloth.

Another example embodiment provides a method of forming a magnesium oxysulfate plate, the method including: preparing a sizing agent; disposing the sizing agent within a die; disposing a plurality of fibrous layers within the sizing agent; and curing the sizing agent with the plurality of fibrous layers disposed therein to produce the magnesium oxysulfate plate. In some cases, preparing the sizing agent includes: providing 80-240 portions of a magnesium sulfate solution having a density of about 23-28° Bé; adding tartrate, a styrene-butadiene emulsion, and a water-reducing agent to the magnesium sulfate solution; adding 85% light calcined magnesia and a heavyweight filler to the resultant mixture; and adding a lightweight filler to the resultant mixture. In some such cases, the tartrate, the styrene-butadiene emulsion, and the water-reducing agent are added in the following weights: about 0.1-5 portions tartrate; about 2-10 portions styrene-butadiene emulsion; and about 0.1-5 portions of water-reducing agent. In some other such cases, the 85% light calcined magnesia, the heavyweight filler, and the lightweight filler are added in the following weights: 100-300 portions of the 85% light calcined magnesia; 0-100 portion(s) of the heavyweight filler; and 0-100 portion(s) of the lightweight filler. In some instances, disposing the sizing agent within the die includes: disposing a first quantity of the sizing agent within the die; disposing a second quantity of the sizing agent over the first quantity of the sizing agent within the die; and disposing a third quantity of the sizing agent over the second quantity of the sizing agent within the die. In some such instances, disposing the plurality of fibrous layers within the sizing agent includes: disposing at least one fibrous layer over the first quantity of the sizing agent prior to disposing the second quantity of the sizing agent over the first quantity of the sizing agent; and disposing at least one fibrous layer over the second quantity of the sizing agent prior to disposing the third quantity of the sizing agent over the second quantity of the sizing agent. In some cases: (1) the sizing agent includes: a backing materials component; an intermediate materials component; and a surface materials component; and (2) disposing the sizing agent within the die includes: first disposing the backing materials component within the die; then disposing the intermediate materials component over the backing materials component within the die; and then disposing the surface materials component over the intermediate materials component within the die. In some such cases, disposing the plurality of fibrous layers within the sizing agent includes: disposing at least one fibrous layer over the backing materials component prior to disposing the intermediate materials component over the backing materials component; and disposing at least one fibrous layer over the intermediate materials component prior to disposing the surface materials component over the intermediate materials component. In some instances, curing the sizing agent with the plurality of fibrous layers disposed therein includes: exposing the sizing agent to an environment having a temperature in the range of about 15-35° C. for about 12 hours or greater. In some cases, the method further includes: removing the magnesium oxysulfate plate from the die; and further curing the magnesium oxysulfate plate for about 4-6 days or more.

Another example embodiment provides a structural insulated panel including: a first magnesium oxysulfate plate; a second magnesium oxysulfate plate disposed adjacent the first magnesium oxysulfate plate; and an insulating layer disposed between the first magnesium oxysulfate plate and the second magnesium oxysulfate plate. In some cases, at least one of the first magnesium oxysulfate plate and the second magnesium oxysulfate plate includes: a sizing agent of homogeneous material composition; and a plurality of fibrous layers disposed within the sizing agent. In some other cases, at least one of the first magnesium oxysulfate plate and the second magnesium oxysulfate plate includes: a sizing agent of heterogeneous material composition; and a plurality of fibrous layers disposed within the sizing agent. In some instances, the insulating layer includes at least one of expanded polystyrene foam (EPS), extruded polystyrene foam (XPS), polyisocyanurate foam, polyurethane foam, and composite honeycomb (HSC). In some instances, at least one of the first magnesium oxysulfate plate and the second magnesium oxysulfate plate has a chamfered edge.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

These and other features of the present embodiments will be understood better by reading the following detailed description, taken together with the figures herein described. In the drawings, each identical or nearly identical component that is illustrated in various figures may be represented by a like numeral. For purposes of clarity, not every component may be labeled in every drawing. Furthermore, as will be appreciated in light of this disclosure, the accompanying drawings are not intended to be drawn to scale or to limit the described embodiments to the specific configurations shown.

FIG. 1 illustrates an isometric view of an example structural insulated panel (SIP) including an insulating layer sandwiched between magnesium oxysulfate (MOS) plates configured in accordance with an embodiment of the present disclosure.

FIG. 2A is a partial cross-sectional view of a MOS plate configured in accordance with an embodiment of the present disclosure.

FIG. 2B is a partial cross-sectional view of a MOS plate configured in accordance with another embodiment of the present disclosure.

FIG. 3A is a partial cross-sectional view of a pair of SIPs including MOS plates joined together in accordance with an embodiment of the present disclosure.

FIG. 3B is a partial cross-sectional view of a pair of SIPs including MOS plates having chamfered portions joined together in accordance with another embodiment of the present disclosure.

FIG. 4A is a flow diagram illustrating a process of making a MOS plate in accordance with an embodiment of the present disclosure.

FIG. 4B is a flow diagram illustrating a process of making a MOS plate in accordance with another embodiment of the present disclosure.

FIG. 5A illustrates a cross-sectional view of an example die configured in accordance with an embodiment of the present disclosure.

FIG. 5B illustrates a cross-sectional view of the example die of FIG. 5A after disposing an example mold therein, in accordance with an embodiment of the present disclosure.

FIG. 5C illustrates a cross-sectional view of the example die of FIG. 5B after disposing a first amount of a sizing agent therein over an optional mold, in accordance with an embodiment of the present disclosure.

FIG. 5D illustrates a cross-sectional view of the example die of FIG. 5C after disposing one or more fibrous layers therein over the first amount of the sizing agent, in accordance with an embodiment of the present disclosure.

FIG. 5E illustrates a cross-sectional view of the example die of FIG. 5D after disposing a second amount of the sizing agent therein over the one or more fibrous layers, in accordance with an embodiment of the present disclosure.

FIG. 5F illustrates a cross-sectional view of the example die of FIG. 5E after disposing one or more fibrous layers therein over the second amount of the sizing agent, in accordance with an embodiment of the present disclosure.

FIG. 5G illustrates a cross-sectional view of the example die of FIG. 5F after disposing a third amount of the sizing agent therein over the one or more fibrous layers, in accordance with an embodiment of the present disclosure.

FIG. 5H illustrates a cross-sectional view of the example die of FIG. 5G during calendering via a calender roller, in accordance with an embodiment of the present disclosure.

FIG. 5I illustrates a cross-sectional view of an example MOS plate after removal from the example die of FIG. 5H, in accordance with an embodiment of the present disclosure.

FIG. 6A illustrates an example extrusion process for forming a mold configured in accordance with an embodiment of the present disclosure.

FIG. 6B illustrates an example process for disposing a mold within a die in accordance with an embodiment of the present disclosure.

### DETAILED DESCRIPTION

Techniques are disclosed for providing a high-strength, water-resistant, fire-proof magnesium oxysulfate (MOS) plate. In accordance with some embodiments, the MOS plate may include one or more fibrous layers disposed within a sizing agent. The sizing agent may include backing materials, intermediate materials, and surface materials components. In some embodiments, the sizing agent may be homogeneous, such that its backing, intermediate, and surface materials components are all of the same material composition. In other embodiments, the sizing agent may be heterogeneous, such that one or more of its backing, intermediate, and surface materials components differ in material composition relative to other component(s). In accordance with some embodiments, a MOS plate provided via the disclosed techniques may be utilized, for example, as a cementitious skin of a structural insulated panel (SIP). Numerous configurations and variations will be apparent in light of this disclosure.

General Overview

Magnesium oxychloride (MOC) cement, sometimes called Sorel cement or magnesia cement, is formed by mixing magnesium chloride (MgCl₂) with magnesium oxide (MgO) and water (H₂O) in a particular stoichiometric ratio. Various fillers optionally may be added to produce a cement material suitable, for example, for fire-proofing or providing firewalls or other fire barriers. However, MOC cement has generally poor water resistance because its hydrate is hydrophilic. Through dissolution or hydrolysis, water can cause MOC cement to lose its crystal structure stability and disintegrate. In fact, water can dramatically weaken the strength of hardened MOC cement, its softening coefficient being in the range of only about 0.2-0.4. Moreover, subjecting a MOC cement product to an environment that is damp or otherwise of sufficiently high humidity can cause halogenide formation on its surfaces, the product becoming stained with a readily visible white, viscous material. Consequently, MOC cement is generally not amenable to use in aquatic or high-moisture (e.g., rain, humidity, etc.) environments.

In addition, scumming may result from residual MgCl₂ in the MOC cement and can occur at any point during curing, knockout, construction, or demolition. When scumming occurs, small white spots may form on the surface of the product, in some cases progressing to a widespread layer of whitish powder with an appearance similar to that of hoar frost. Scumming can persist long into the life of the product, often lasting for many years.

Furthermore, MOC cement is susceptible to buckling deformation, thermal expansion, and spalling. During hardening, MOC cement releases a high quantity of heat, typically in the range of about 1,000-1,350 J/g MgO, whereas the heat of hydration for ordinary cement is only 300-400 J/g. Reaction systems can have temperatures up to about 140° C., in some cases exceeding 150° C. As MOC cement has a relatively quick setting time and a large heat release that can cause product buckling deformation, large volumes of MOC cement tend to incur micro-cracking, which can enlarge and deepen, making the product gradually crumble.

Currently, there are some techniques which can be employed in effort to improve these noted drawbacks of MOC cement. For instance, additives, such as spray polyurethane foams (SPFs), phosphoric acid, phosphate, calcium aluminate, low-molecular-weight organic polymers, and water-proofing agents, can be added to change crystal appearance and block pores of MOC cement. Optimal stirring processing parameters may be selected to enhance the reaction capacity of MgO and MgCl₂, as well as improve the crystal structure of the resultant MOC cement and enhance its compactness and water-resistance. In processing to form MOC cement, the molar ratio and water consumption of MgO and MgCl₂ may be strictly controlled. However, these additives and processing requirements dramatically increase cost and ultimately do not solve the aforementioned problems associated with MOC cement.

Thus, and in accordance with some embodiments of the present disclosure, techniques are disclosed for providing a high-strength, water-resistant, fire-proof magnesium oxysulfate (MOS) plate. In accordance with some embodiments, the MOS plate may include one or more fibrous layers disposed within a sizing agent. The sizing agent may include backing materials, intermediate materials, and surface materials components. In some embodiments, the sizing agent may be homogeneous, such that its backing, intermediate, and surface materials components are all of the same material composition. In other embodiments, the sizing agent may be heterogeneous, such that one or more of its backing, intermediate, and surface materials components differ in material composition relative to other component(s). In accordance with some embodiments, a MOS plate provided via the disclosed techniques may be utilized, for example, as a cementitious skin of a structural insulated panel (SIP).

In accordance with some embodiments, the MOS plate may comprise any one, or combination, of 23-28° Bé magnesium sulfate solution, 85% light calcined magnesia, tartrate, styrene-butadiene emulsion, heavyweight fillers, lightweight fillers, and a water-reducing agent, the amounts of which can be customized, as desired for a target application or end-use. In accordance with an example embodiment, a MOS plate may be formed by adding water to magnesium sulfate solution to adjust its density to within the range of about 23-28° Bé. Then, 0.1-5 portions of tartrate may be added. Then, 2-10 portions of styrene-butadiene emulsion may be added. As the styrene-butadiene emulsion has hardenability due to heating, it can effectively enhance the water-resistance and toughness of the MOS plate, at least in some instances. Then, 0.1-5 portions of water-reducing agent may be added into the magnesium sulfate solution and made even by stirring. In some instances, the water-reducing agent can control the proportion of the molar ratio of materials. Then, 100-300 portions of 85% light calcined magnesia and 0-100 portions of heavyweight fillers may be orderly added and made even by stirring. In some instances, the heavyweight fillers can enhance the compressive strength of the MOS plate. Then, 0-100 portions of lightweight fillers may be added and made even by stirring. In some instances, the lightweight fillers can reduce the density and reduce the weight of the MOS plate. Then, the resultant mixture may be divided and poured into a prepared die, being layered with one or more fibrous layer(s). In some instances, the fibrous layer(s) may enhance the breaking strength of the MOS plate. Then, the die and its contents may be placed in a curing room or other ventilated environment conducive to curing, where the die and its contents may be exposed to a temperature in the range of about 15-35° C. for about 12 hours or more. Thereafter, the MOS plate may be knocked out of the die and subjected to additional curing, if desired.

In accordance with some embodiments, a MOS plate provided via the disclosed techniques optionally may have one or more chamfered reinforced edges, providing a finish-ready surface which can physically accommodate the presence of joint tape and joint compound. That is, at least in some instances, the disclosed techniques may be utilized to provide a finish-ready joint between MOS plates that is flush or otherwise substantially co-planar with the surface of those MOS plates without compromising the structural integrity of the joint which would occur otherwise through removal of a reinforcing mesh at the edges. The MOS plate may be provided with recessed edges that contain fiberglass or other reinforcing mesh layers for reinforcement and structural use with the recessed edges adapted, for instance, to receive tape and a joint compound in the recess to a level flush with the surface of the MOS plate. When MOS plates having the reinforced tapered edges are to be joined together at their edges (e.g., via underlying shims and fasteners), the resulting joint may have significant structural integrity and may provide a recess for receiving joint compound that can be made flush with the plane of the MOS plates.

As will be apparent in light of this disclosure, the disclosed techniques can be employed, in accordance with some embodiments, via a production line including, for example, a conveyor, a slurry dispensing apparatus configured to dispense the sizing agent into dies on the conveyor, and one or more calibration or calender rollers to compress the slurry within the dies as they pass along the conveyor.

In some cases, a MOS plate provided via the techniques disclosed herein may exhibit any one, or combination, of: (1) low thermal expansion and shrinkage rate; (2) low heat conductivity coefficient; (3) high strength; (4) high water resistance; (5) null buckling deformation; (6) a softening coefficient of about 0.95 or greater; (7) halogenide formation resistance; (8) scumming resistance; (9) good freezing resistance; and (10) non-inflammability.

Structures

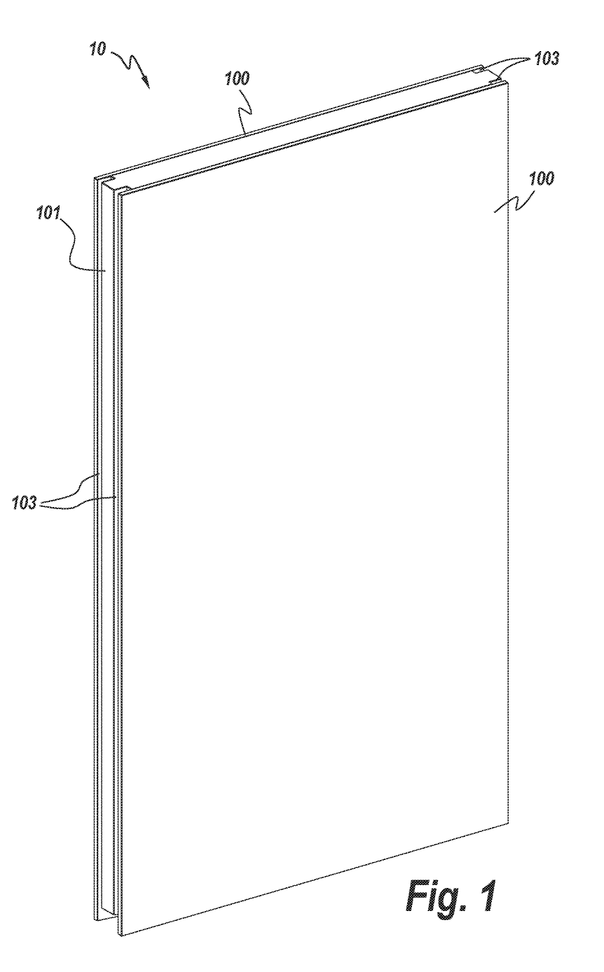

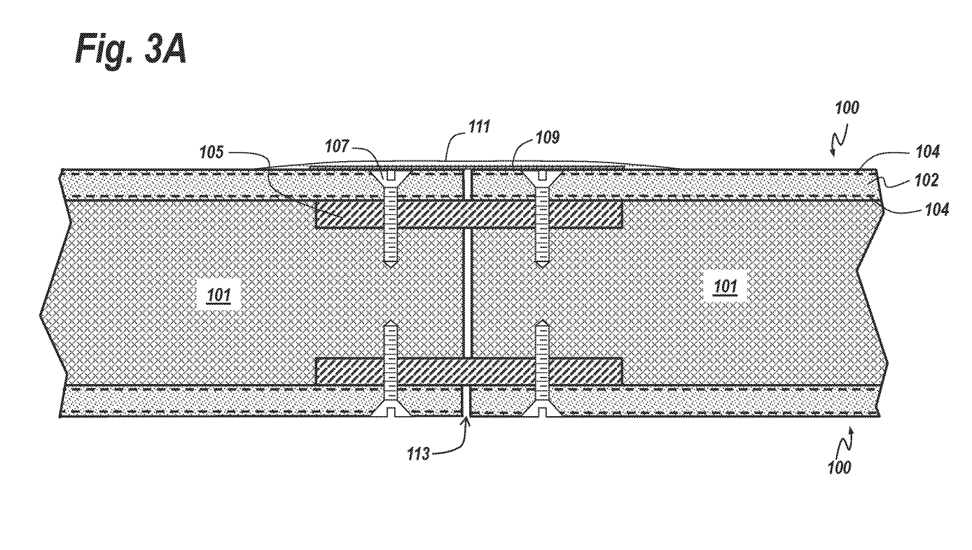

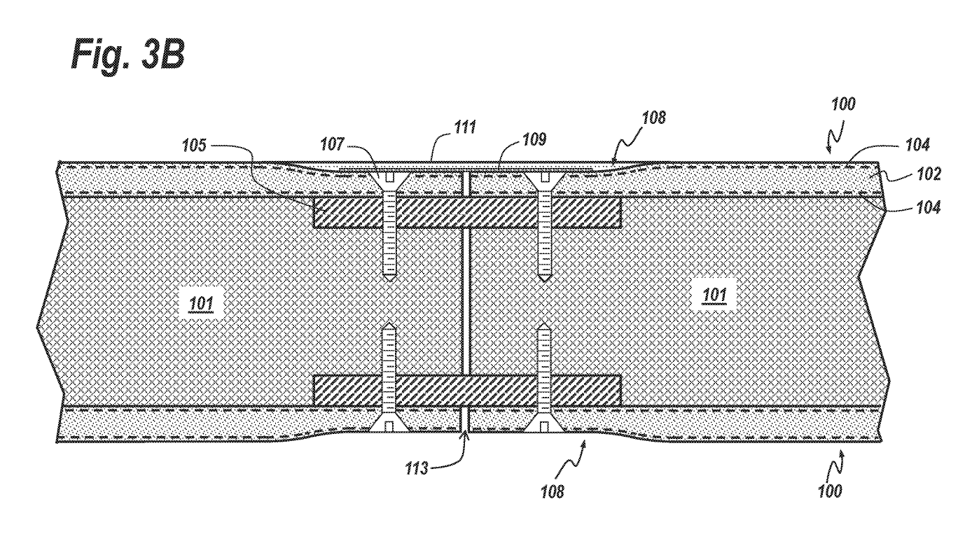

FIG. 1 illustrates an isometric view of an example structural insulated panel (SIP) 10 including an insulating layer 101 sandwiched between MOS plates 100 configured in accordance with an embodiment of the present disclosure. One or more grooves 103 may be formed in insulating layer 101 and configured to receive shims 105 (FIGS. 3A-3B) to provide for joining of adjacent SIPs 10, in accordance with some embodiments.

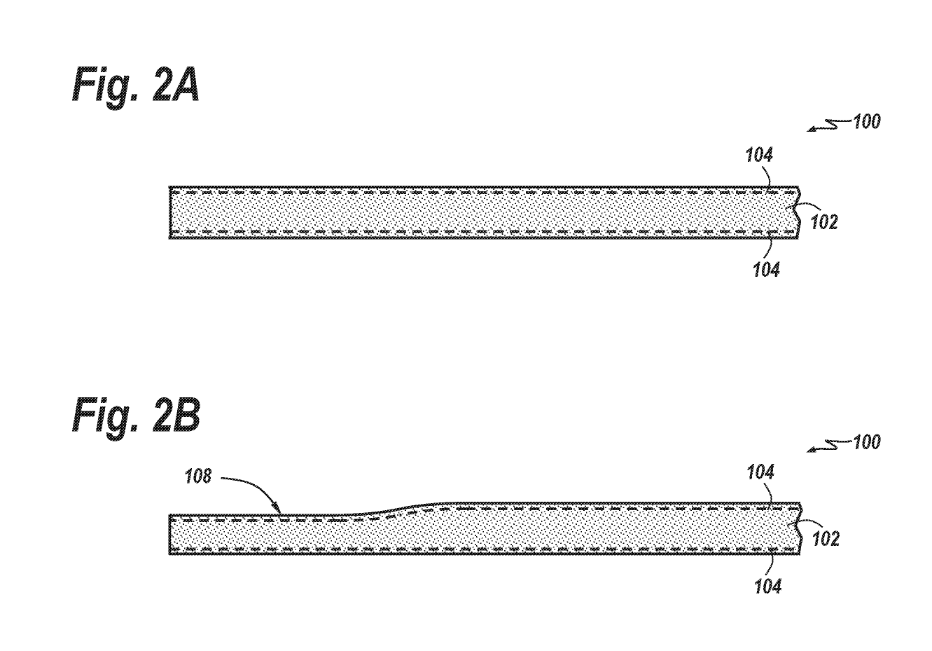

MOS plate 100 may have any of a wide range of configurations. For example, consider FIG. 2A, which is a partial cross-sectional view of a MOS plate 100 configured in accordance with an embodiment of the present disclosure. Also, consider FIG. 2B, which is a partial cross-sectional view of a MOS plate 100 configured in accordance with another embodiment of the present disclosure. As can be seen from these figures, MOS plate 100 includes one or more fibrous layers 104 at least partially disposed within a cured sizing agent 102 (each discussed below). As can be seen further from FIG. 1B, in some embodiments, MOS plate 100 optionally may include one or more chamfered portions 108 (discussed below).

The sizing agent 102 of MOS plate 100 may include any of a wide range of materials, in any of a wide range of quantities. For instance, in accordance with some embodiments, sizing agent 102 may include, at one or more times during its formation, any one (or combination) of 23-28° Bé magnesium sulfate solution, 85% light calcined magnesia, tartrate, styrene-butadiene emulsion, heavyweight fillers, lightweight fillers, and a water-reducing agent. Some example suitable heavy filling materials include coal ash, ground limestone, kaoline, dolomite dust, calcium carbonate heavy, quartz sand, and talcum powder, among others. Some example suitable light filling materials include plant fiber, lightweight perlite, lightweight vermiculite, and glass beads, among others. Some example suitable water-reducing agents include polycarboxylate superplasticizer and naphthalene water reducer, among others. Additional details on the material composition and formation processes related to sizing agent 102 are detailed below. Other suitable heavy filling materials, light filling materials, and water-reducing agents for sizing agent 102 will depend on a given application and will be apparent in light of this disclosure.

In accordance with some embodiments, sizing agent 102 may be formed as a homogeneous structure, wherein its constituent backing materials component, intermediate materials component, and surface materials component have the same material composition. The resultant sizing agent 102 may be considered, in a general sense, a single layer of relatively uniform material composition. To that end, sizing agent 102 may be formed from a single slurry (or other mixture) of materials, as described below.

In accordance with some other embodiments, sizing agent 102 may be formed as a heterogeneous structure, wherein its constituent backing materials component, intermediate materials component, and surface materials component are not of the same material composition. The resultant sizing agent 102 may be considered, in a general sense, a stack of layers, each individual layer being of relatively uniform material composition but differing from one or more adjacent layers. Thus, as between any two such constituent layers, differences in material composition may be provided (e.g., a first constituent layer may be of a first material composition, and a second constituent layer may be of a different, second material composition). To that end, sizing agent 102 may be formed from a plurality of slurries (or other mixtures) of materials, as described below.

A given fibrous layer 104 of MOS plate 100 may include any of a wide range of fibrous materials. For instance, a given fibrous layer 104 may include any one, or combination, of fiberglass, C-glass, carbon fiber cloth, steel wire gauze, short fiber, steel fiber, and fiber mesh cloth, among other fibrous materials. In some cases, MOS plate 100 may include only a single fibrous layer 104 at a given location within sizing agent 102 (e.g., a single fibrous layer 104 with no additional fibrous layer 104 immediately adjacent thereto). In some other cases, MOS plate 100 may include a plurality of fibrous layers 104 at a given location within sizing agent 102 (e.g., two, three, four, or more fibrous layers 104 immediately adjacent to one another). The dimensions (e.g., thickness) of a given fibrous layer 104 may be customized, as desired for a given target application or end-use. A given fibrous layer 104 may serve, at least in part, to provide structural reinforcement to MOS plate 100, at least in some instances.

In accordance with some embodiments, MOS plate 100 optionally may be formed with one or more chamfered portions 108, as described below. With a given chamfered portion 108, the localized thickness of MOS plate 100 may be tapered, yet one or more fibrous layers 104 may remain intact thereat, providing localized structural reinforcement. To such ends, one or more molds 202 (discussed below) may be employed during formation of MOS plate 100, in accordance with some embodiments.

Returning to FIG. 1, insulating layer 101 may have any of a wide range of configurations. Insulating layer 101 may be formed from any one, or combination, of insulating materials, such as, for example, expanded polystyrene foam (EPS), extruded polystyrene foam (XPS), polyisocyanurate foam, polyurethane foam, and composite honeycomb (HSC), to name a few. The dimensions (e.g., thickness) of insulating layer 101 may be customized, as desired for a given target application or end-use. Insulating layer 101 may be adhered to MOS plates 100 via any suitable adhesive material(s), as will be apparent in light of this disclosure.

FIG. 3A is a partial cross-sectional view of a pair of SIPs 10 including MOS plates 100 joined together in accordance with an embodiment of the present disclosure. FIG. 3B is a partial cross-sectional view of a pair of SIPs 10 including MOS plates 100 having chamfered portions 108 joined together in accordance with another embodiment of the present disclosure. As can be seen, neighboring SIPs 10, whether including MOS plates 100 with (FIG. 3B) or without (FIG. 3A) chamfered portion(s) 108, may be joined together via shims 105 inserted within grooves 103 and fastened together via fasteners 107, in accordance with some embodiments. Joint tape 109 and joint compound 111 may be applied (as typically done) over joint 113 between joined SIPs 10. In cases in which MOS plates 100 include chamfered portions 108 (FIG. 3B), the recess provided by those chamfered portions 108 may accommodate the presence of joint tape 109 and joint compound 111 such that those materials do not stand proud of the plane of the surface of MOS plates 100. Thus, joint compound 111 (with joint tape 109 beneath it) may be made substantially co-planar with the surface of MOS plates 100, in accordance with some embodiments.

Methodologies

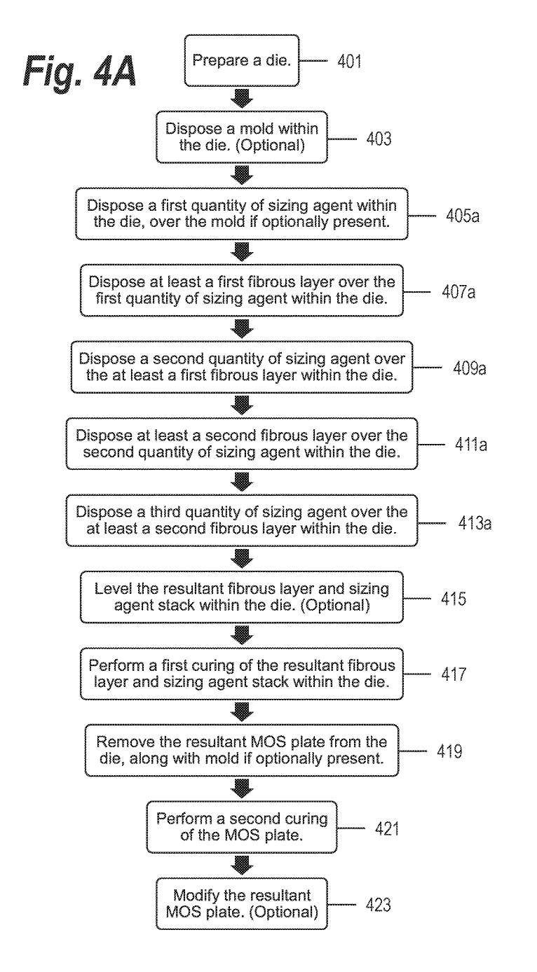

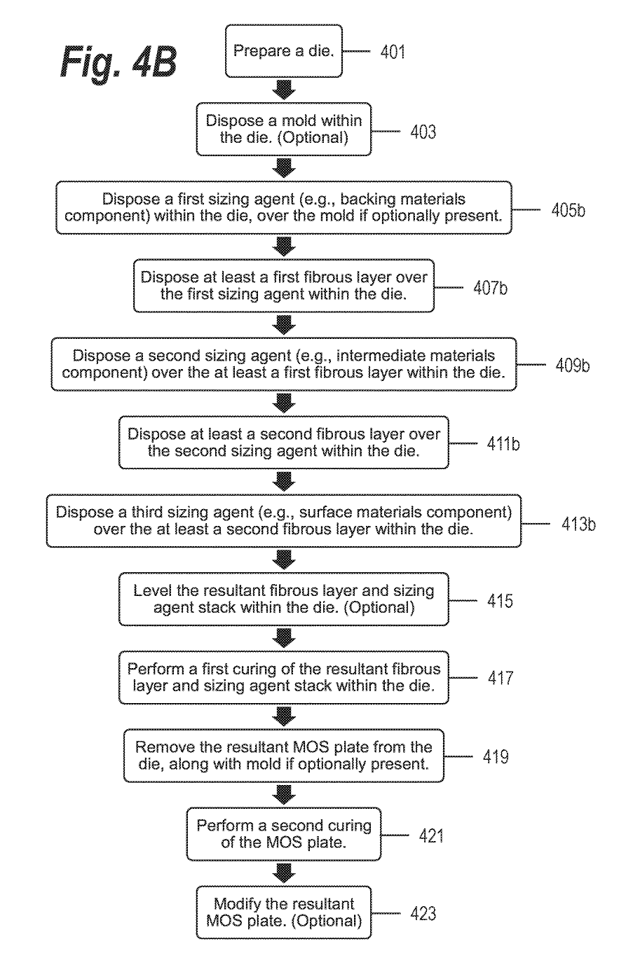

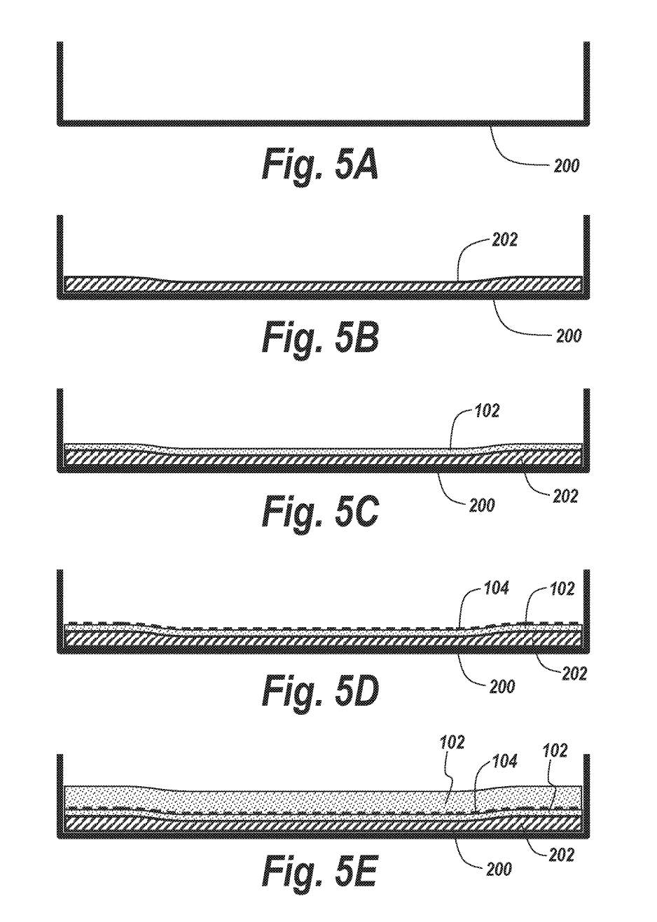

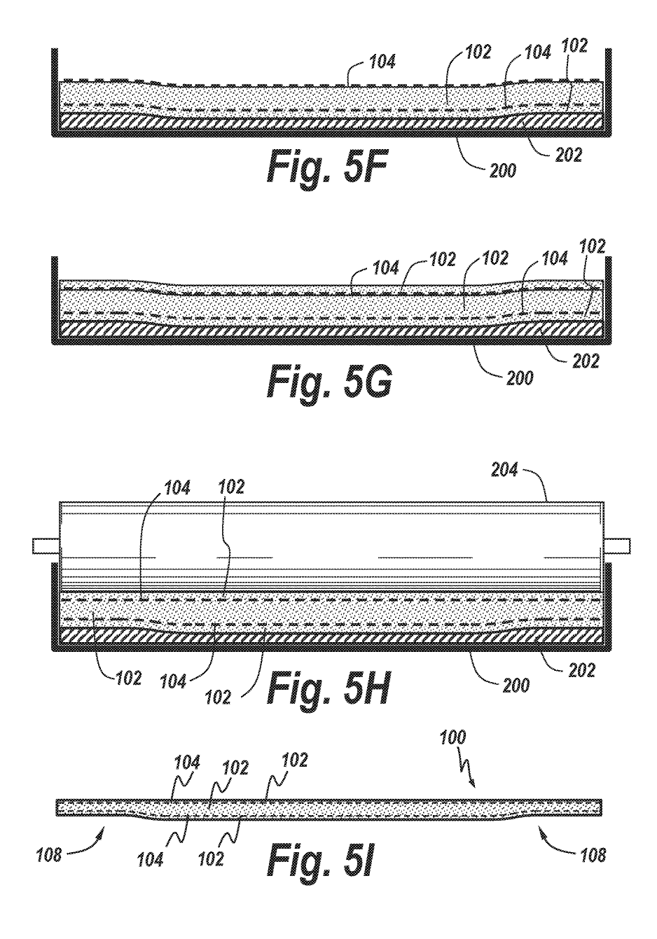

FIG. 4A is a flow diagram illustrating a process of making a MOS plate 100 in accordance with an embodiment of the present disclosure. The process may begin as in block 401 with preparing a die 200 (or other suitable carrier). Die 200 may be any suitable preform body of any given shape and dimensions, as desired for a given target application or end-use. In some instances, die 200 may be of generally quadrilateral geometry (e.g., square, rectangle, and so forth). FIG. 5A illustrates a cross-sectional view of an example die 200 configured in accordance with an embodiment of the present disclosure. Numerous suitable configurations and variations for die 200 will be apparent in light of this disclosure.

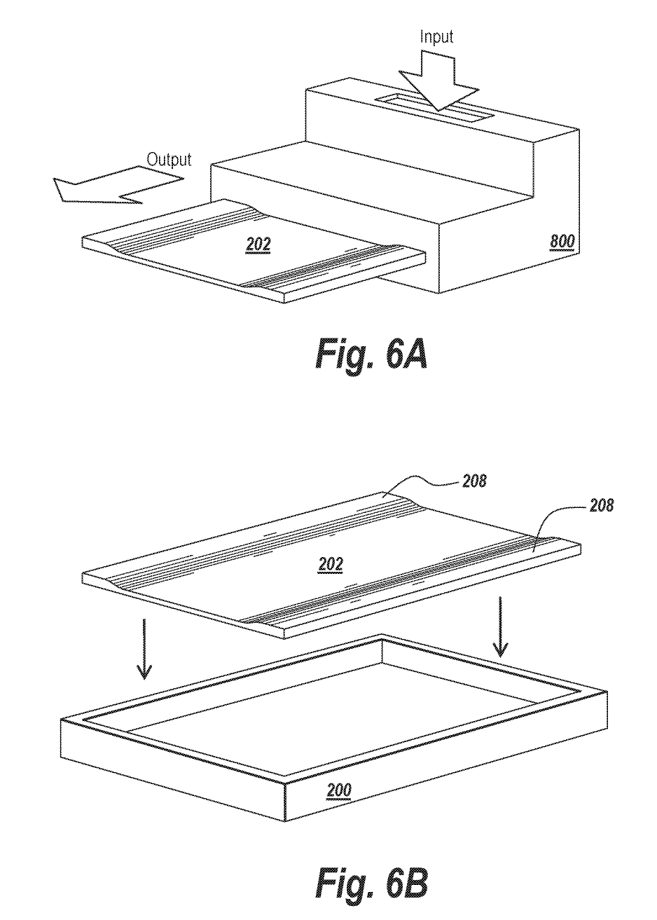

The process may continue as in block 403 with optionally disposing a mold 202 within die 200. Optional mold 202 may be formed, in part or in whole, via any suitable process(es), such as, for example, an extrusion process, as generally shown via FIG. 6A. In an example case, an acrylic melt (or other suitable thermoform or thermoset material) may be provided as input to an extruder 800. Extruder 800 may output a partial or complete mold 202. In some instances, mold 202 optionally may include one or more raised portions 208 which are configured to provide a corresponding number of optional chamfered portions 108 for a given MOS plate 100 formed therewith. After formation, mold 202 optionally may be disposed within die 200, as generally shown via FIG. 6B. FIG. 5B illustrates a cross-sectional view of the example die 200 of FIG. 5A after disposing an example mold 202 therein, in accordance with an embodiment of the present disclosure. As will be appreciated in light of this disclosure, the dimensions and geometry of optional mold 202 may be commensurate with that of die 200 to ensure a given desired fit there between. Numerous suitable configurations and variations for optional mold 202 will be apparent in light of this disclosure.

The process may continue as in block 405a with disposing a first quantity of a sizing agent 102 within die 200. In accordance with some embodiments, sizing agent 102 may be a slurry (or other mixture) delivered to die 200, for example, via a slurry injection funnel or any other suitable device for dispensing sizing agent 102, as will be apparent in light of this disclosure. If a mold 202 is optionally present within die 200, then the first quantity of sizing agent 102 may be disposed over that mold 202, such that one or more chamfered portions 108 (or other contours or features) ultimately result in the finished MOS plate 100. The particular volume, mass, or other desired measure of the first quantity of sizing agent 102 may be customized, as desired for a given target application or end-use. FIG. 5C illustrates a cross-sectional view of the example die 200 of FIG. 5B after disposing a first amount of sizing agent 102 therein over optional mold 202, in accordance with an embodiment of the present disclosure.

The process may continue as in block 407a with disposing at least a first fibrous layer 104 over the first quantity of sizing agent 102. In so doing, the at least a first fibrous layer 104 may come to reside, in part or in whole, within the first quantity of sizing agent 102, at least in some instances. At this point in the process, the quantity of fibrous layers 104 may be customized, as desired for a given target application or end-use. In some cases, only a single fibrous layer 104 may be so disposed, whereas in some other cases, multiple fibrous layers 104 may be so disposed. FIG. 5D illustrates a cross-sectional view of the example die 200 of FIG. 5C after disposing one or more fibrous layers 104 therein over the first amount of sizing agent 102, in accordance with an embodiment of the present disclosure.

The process may continue as in block 409a with disposing a second quantity of the sizing agent 102 within die 200. In so doing, the at least a first fibrous layer 104 may come to reside, in part or in whole, within the second quantity of sizing agent 102, at least in some instances. In some cases, some mixing of the first and second quantities of sizing agent 102 may occur. The particular volume, mass, or other desired measure of the second quantity of sizing agent 102 may be customized, as desired for a given target application or end-use. FIG. 5E illustrates a cross-sectional view of the example die 200 of FIG. 5D after disposing a second amount of sizing agent 102 therein over one or more fibrous layers 104, in accordance with an embodiment of the present disclosure.

The process may continue as in block 411a with disposing at least a second fibrous layer 104 over the second quantity of sizing agent 102. In so doing, the at least a second fibrous layer 104 may come to reside, in part or in whole, within the second quantity of sizing agent 102, at least in some instances. At this point in the process, the quantity of fibrous layers 104 may be customized, as desired for a given target application or end-use. In some cases, only a single fibrous layer 104 may be so disposed, whereas in some other cases, multiple fibrous layers 104 may be so disposed. FIG. 5F illustrates a cross-sectional view of the example die 200 of FIG. 5E after disposing one or more fibrous layers 104 therein over the second amount of sizing agent 102, in accordance with an embodiment of the present disclosure.

The process may continue as in block 413a with disposing a third quantity of the sizing agent 102 within die 200. In so doing, the at least a second fibrous layer 104 may come to reside, in part or in whole, within the third quantity of sizing agent 102, at least in some instances. In some cases, some mixing of the second and third quantities of sizing agent 102 may occur. The particular volume, mass, or other desired measure of the third quantity of sizing agent 102 may be customized, as desired for a given target application or end-use. FIG. 5G illustrates a cross-sectional view of the example die 200 of FIG. 5F after disposing a third amount of sizing agent 102 therein over one or more fibrous layers 104, in accordance with an embodiment of the present disclosure.

The process optionally may continue as in block 415 with leveling the resultant stack of fibrous layer(s) 104 and sizing agent 102 within die 200. To that end, die 200 and its contents may be passed through one or more calibration or calender rollers 204 (or other pressure application elements) which contact the top surface of sizing agent 102 and thus compress it and fibrous layer(s) 104 within die 200 (e.g., into/onto optional mold 202, if present). FIG. 5H illustrates a cross-sectional view of the example die 200 of FIG. 5G during calendering via a calender roller 204, in accordance with an embodiment of the present disclosure.

The process may continue as in block 417 with performing a first curing of the resultant stack of fibrous layer(s) 104 and sizing agent 102 within die 200. To that end, die 200 and its contents may be disposed in a ventilated environment conducive to curing. During this first curing, die 200 and its contents may be exposed to a temperature, for example, in the range of about 15-35° C. (e.g., about 15-20° C., about 20-25° C., about 25-30° C., about 30-35° C., or any other sub-range in the range of about 15-35° C.), in accordance with some embodiments. The first curing process may endure, for example, for about 8 hours or more (e.g., about 10 hours or more, about 12 hours or more, about 14 hours or more, and so forth).

At this point in the process, the stack of fibrous layer(s) 104 and sizing agent 102, having undergone at least the first curing, may be considered an at least partially completed MOS plate 100. In some instances, MOS plate 100 may be a substantially planar panel of relatively uniform thickness. In some other instances, however, such as when a mold 202 including raised portion(s) 208 is employed, MOS plate 100 may be a substantially planar panel including portion(s) of different relative thickness (e.g., such as in the region of a given chamfered portion 108). Thus, in an example case, a chamfered portion 108 of MOS plate 100 may have a first thickness, and a different portion (e.g., central portion) of MOS plate 100 may have a greater or otherwise different second thickness.

After the first curing, the process may continue as in block 419 with removing the resultant MOS plate 100 from die 200. This removal process, sometimes called knockout, results in separation of MOS plate 100 from die 200, as well as mold 202, if optionally present. If mold 202 is optionally present within die 200, then it too may be removed in the process of emptying die 200 of its contents. FIG. 5I illustrates a cross-sectional view of an example MOS plate 100 after removal from the example die 200 of FIG. 5H, in accordance with an embodiment of the present disclosure.

After removal, the process may continue as in block 421 with performing a second curing of MOS plate 100. To that end, MOS plate 100 may be disposed in a ventilated environment conducive to curing. For instance, MOS plate 100 may be disposed in a dry, air-ventilated curing house or other suitable curing environment. The second curing process may endure, for example, for about 4 days or more (e.g., about 5 days, 6 days, 7 days, or more).

After secondary curing is complete, the resultant MOS plate 100 optionally may undergo one or more modifications, for example, to reduce ragged edges, smooth rough surfaces, or achieve specific dimensions. For instance, the ends of MOS plate 100 may be trimmed via a double end trim saw or other suitable trimming technique, as will be apparent in light of this disclosure. The surfaces of MOS plate 100 may be flattened via sand flattening or other suitable flattening technique, as will be apparent in light of this disclosure.

FIG. 4B is a flow diagram illustrating a process of making a MOS plate 100 in accordance with another embodiment of the present disclosure. The process may begin as in blocks 401 and 403 (optional), as described above with respect to FIG. 6A. The process may continue as in block 405b with disposing a quantity of a first sizing agent 102 within die 200. In accordance with some embodiments, the first sizing agent 102 may be a slurry (or other mixture) delivered to die 200, for example, via a slurry injection funnel or any other suitable device for dispensing sizing agent 102, as will be apparent in light of this disclosure. If a mold 202 is optionally present within die 200, then the quantity of the first sizing agent 102 may be disposed over that mold 202, such that one or more chamfered portions 108 (or other contours or features) ultimately result in the finished MOS plate 100. The particular volume, mass, or other desired measure of the quantity of the first sizing agent 102 may be customized, as desired for a given target application or end-use. In this case, returning to FIG. 5C, the illustrated first sizing agent 102 layer disposed within die 200 would constitute this first sizing agent 102.

The process may continue as in block 407b with disposing at least a first fibrous layer 104 over the quantity of the first sizing agent 102. In so doing, the at least a first fibrous layer 104 may come to reside, in part or in whole, within the quantity of the first sizing agent 102, at least in some instances. At this point in the process, the quantity of fibrous layers 104 may be customized, as desired for a given target application or end-use. In some cases, only a single fibrous layer 104 may be so disposed, whereas in some other cases, multiple fibrous layers 104 may be so disposed.

The process may continue as in block 409b with disposing a quantity of a second sizing agent 102 within die 200. In so doing, the at least a first fibrous layer 104 may come to reside, in part or in whole, within the quantity of the second sizing agent 102, at least in some instances. In some cases, some mixing of the quantities of the first and second sizing agents 102 may occur. The particular volume, mass, or other desired measure of the quantity of the second sizing agent 102 may be customized, as desired for a given target application or end-use. In this case, returning to FIG. 5E, the illustrated newly added second sizing agent 102 layer disposed within die 200 would constitute this second sizing agent 102.

The process may continue as in block 411b with disposing at least a second fibrous layer 104 over the quantity of the second sizing agent 102. In so doing, the at least a second fibrous layer 104 may come to reside, in part or in whole, within the quantity of the second sizing agent 102, at least in some instances. At this point in the process, the quantity of fibrous layers 104 may be customized, as desired for a given target application or end-use. In some cases, only a single fibrous layer 104 may be so disposed, whereas in some other cases, multiple fibrous layers 104 may be so disposed.

The process may continue as in block 413b with disposing a quantity of a third sizing agent 102 within die 200. In so doing, the at least a second fibrous layer 104 may come to reside, in part or in whole, within the quantity of the third sizing agent 102, at least in some instances. In some cases, some mixing of the quantities of the second and third sizing agents 102 may occur. The particular volume, mass, or other desired measure of the quantity of the third sizing agent 102 may be customized, as desired for a given target application or end-use. In this case, returning to FIG. 5G, the illustrated newly added third sizing agent 102 layer disposed within die 200 would constitute this third sizing agent 102.

In accordance with some embodiments, the process may continue as in block 415 (optional), block 417, block 419, block 421, and block 423 (optional), as described above with respect to FIG. 6A.

In accordance with some embodiments, the process flows of FIGS. 4A and 4B may be implemented, in part or in whole, in a given desired order. Thus, although the functional blocks are illustrated and described in an example order, other orders different from that shown or discussed, including performing the actions of multiple blocks substantially concurrently or in a reversed order, may be provided, in accordance with some other embodiments. Numerous variations on the methods of FIGS. 4A and 4B will be apparent in light of this disclosure.

### Example 1

Example 1 is a high-strength, water-resistant, fire-proof MOS plate 100 including a plurality of fibrous layers 104 and a sizing agent 102 of homogeneous material composition. In this example, the sizing agent 102 includes as its constituents: (1) a backing materials component; (2) an intermediate materials component; and a (3) surface materials component. In this example, each of these components is of the same material composition according to the following weights: 240 portions of 25° Bé magnesium sulfate solution; 300 portions of 85% light calcined magnesia; 90 portions of coal ash; 60 portions of saw powder; 30 portions of lightweight perlite; 1 portion of tartrate; 1 portion of polycarboxylate superplasticizer; and 9 portions of styrene-butadiene emulsion.

In this example, the following process was employed to produce a high-strength, water-resistant, fire-proof MOS plate 100.

Prepare the sizing agent 102. Take 240 portions of water-adjusted 25° Bé magnesium sulfate solution, orderly add 1 portion of tartaric acid and 1 portion of polycarboxylate superplasticizer and then evenly stir for 2 minutes. Then, orderly add 300 portions of 85% light calcined magnesia and 90 portions of coal ash and stir for 2 minutes. Then, add 60 portions of saw powder and 30 portions of lightweight perlite and stir for 2 minutes. Then, add 9 portions of styrene-butadiene emulsion and stir for 5 minutes.

Pour the prepared sizing agent 102 into a prepared die 200. Dispose a first amount of the prepared sizing agent 102 within the die 200, and make it even (e.g., let it settle/level) within the die 200. This first portion constitutes the backing materials component of the sizing agent 102 of the MOS plate 100 to be formed. Then, add at least one fibrous layer 104 over the first amount (i.e., the backing materials component) of the prepared sizing agent 102 within the die 200. Then, dispose a second portion of the prepared sizing agent 102 within the die 200 over the at least one fibrous layer 104, and make it even (e.g., let it settle/level) within the die 200. This second portion constitutes the intermediate materials component of the sizing agent 102 of the MOS plate 100 to be formed. Then, add at least one more fibrous layer 104 over the second amount (i.e., the intermediate materials component) of the prepared sizing agent 102 within the die 200. Then, dispose a third portion of the prepared sizing agent 102 within the die 200 over the at least one more fibrous layer 104, and make it even (e.g., let it settle/level) within the die 200. This third portion constitutes the surface materials component of the sizing agent 102 of the MOS plate 100 to be formed.

Cure the MOS plate 100. Dispose the die 200, along with its contents, in a ventilated environment conducive to curing. In so doing, the die 200 and its contents may be exposed to a temperature in the range of about 15-35° C. (e.g., about 15-20° C., about 20-25° C., about 25-30° C., about 30-35° C., or any other sub-range in the range of about 15-35° C.). After curing for about 12 hours or more, remove (e.g., knock out) the resultant MOS plate 100 from the die 200. Then, dispose the MOS plate 100 once more in a ventilated environment conducive to curing for about 4-6 days.

Of course, as will be appreciated in light of this disclosure, additional or fewer fibrous layers 104 may be utilized, in accordance with some other embodiments. As will be further appreciated, the relative quantities of each of the first, second, and third amounts of the prepared sizing agent 102 may be customized, as desired for a given target application or end-use. As will be further appreciated, the stirring times are not intended to be limited only to the example durations provided.

The example MOS plate 100 made in accordance with the details of Example 1, described above, exhibited the attributes summarized below in Table 1:

TABLE 1

| | |
|---|---|
| Breaking Strength: | >12 MPa |
| Compressive Strength: | >23 MPa |
| Nail-Holding Ability: | >50N |
| Softening Coefficient: | >0.90 |
| Non-Inflammability: | Grade A |
| Water-Resistance: | Good |
| Other Notes: | No metal corrosion, scumming, or absorption |
| | of moisture causing halogenide formation |

### Example 2

Example 2 is a high-strength, water-resistant, fire-proof MOS plate 100 including a plurality of fibrous layers 104 and a sizing agent 102 of heterogeneous material composition. In this example, the sizing agent 102 includes as its constituents: (1) a backing materials component; (2) an intermediate materials component; and (3) a surface materials component. In this example, each of these components is of different material composition from the others. More particularly, the backing materials component (of sizing agent 102) includes materials of the following weights: 80 portions of 25° Bé magnesium sulfate solution; 100 portions of 85% light calcined magnesia; 90 portions of coal ash; 10 portions of kaoline; 30 portions of lightweight perlite; 0.2 portion of tartrate; 0.3 portion of polycarboxylate superplasticizer; and 5 portions of styrene-butadiene emulsion. The intermediate materials component (of sizing agent 102) includes materials of the following weights: 240 portions of 25° Bé magnesium sulfate solution; 300 portions of 85% light calcined magnesia; 100 portions of coal ash; 60 portions of saw powder; 30 portions of lightweight perlite; 0.6 portion of tartrate; 1 portion of polycarboxylate superplasticizer; and 9 portions of styrene-butadiene emulsion. The surface materials component (of sizing agent 102) includes materials of the following weights: 120 portions of 25° Bé magnesium sulfate solution; 150 portions of 85% light calcined magnesia; 50 portions of coal ash; 30 portions of saw powder; 0.3 portion of tartrate; 0.5 portion of polycarboxylate superplasticizer; and 5 portions of styrene-butadiene emulsion.

In this example, the following process was employed to produce a high-strength, water-resistant, fire-proof MOS plate 100.

Prepare the backing materials component of the sizing agent 102. Take 80 portions of water-adjusted 25° Bé magnesium sulfate solution and orderly add 0.2 portions of tartaric acid and 0.3 portions of polycarboxylate superplasticizer and then evenly stir for 2 minutes. Then, orderly add 100 portions of 85% light calcined magnesia, 90 portions of coal ash, and 10 portions of kaoline and stir for 2 minutes. Then, add 30 portions of lightweight perlite and stir for 2 minutes. Then, add 5 portions of styrene-butadiene emulsion and stir for 5 minutes.

Prepare the intermediate materials component of the sizing agent 102. Take 240 portions of water-adjusted 25° Bé magnesium sulfate solution and orderly add 0.6 portions of tartaric acid and 1 portion of polycarboxylate superplasticizer and then evenly stir for 2 minutes. Then, orderly add 300 portions of 85% light calcined magnesia, 100 portions of coal ash, 60 portions of saw powder, and 30 portions of lightweight perlite and stir for 2 minutes. Then, add 9 portions of styrene-butadiene emulsion and stir for 5 minutes.

Prepare the surface materials component of the sizing agent 102. Take 120 portions of water-adjusted 25° Bé magnesium sulfate solution and orderly add 0.3 portion of tartaric acid and 0.5 portion of polycarboxylate superplasticizer and then evenly stir for 2 minutes. Then, orderly add 150 portions of 85% light calcined magnesia, 50 portions of coal ash, and 30 portions of saw powder and stir for 2 minutes. Then, add 5 portions of styrene-butadiene emulsion and stir for 5 minutes.

One at a time, pour the prepared sizing agent 102 components in the die 200. First, dispose the backing materials component within the die 200 and make it even (e.g., let it settle/level) within the die 200. Then, add at least a first fibrous layer 104 over the backing materials component within the die 200. Then, dispose the intermediate materials component within the die 200 over the at least a first fibrous layer 104 and make it even (e.g., let it settle/level) within the die 200. Then, add at least a second fibrous layer 104 over the intermediate materials component within the die 200. Then, dispose the surface materials component within the die 200 over the at least a second fibrous layer 104 and make it even (e.g., let it settle/level) within the die 200.

Dispose the die 200, along with its contents, in a ventilated environment conducive to curing. In accordance with some embodiments, the die 200 and its contents may be exposed to a temperature in the range of about 15-35° C. (e.g., about 15-20° C., about 20-25° C., about 25-30° C., about 30-35° C., or any other sub-range in the range of about 15-35° C.). After curing for about 12 hours or more, remove (e.g., knock out) the resultant MOS plate 100 from the die 200. Then, dispose the MOS plate 100 in a ventilated environment conducive to curing for about 4-6 days.

Of course, as will be appreciated in light of this disclosure, additional or fewer fibrous layers 104 may be utilized, in accordance with some other embodiments. As will be further appreciated, the relative quantities of each of the first, second, and third components of sizing agent 102 may be customized, as desired for a given target application or end-use. As will be further appreciated, the stirring times are not intended to be limited only to the example durations provided.

The example MOS plate 100 made in accordance with the details of Example 2, described above, exhibited the attributes summarized below in Table 2:

TABLE 2

| | |
|---|---|
| Breaking Strength: | >13 MPa |
| Compressive Strength: | >25 MPa |
| Nail-Holding Ability: | >60N |
| Softening Coefficient: | >0.95 |
| Non-Inflammability: | Grade A |
| Water-Resistance: | Good |
| Other Notes: | No metal corrosion, scumming, or absorption |
| | of moisture causing halogenide formation |

### Example 3

Example 3 is a high-strength, water-resistant, fire-proof MOS plate 100 including a plurality of fibrous layers 104 and a sizing agent 102 of heterogeneous material composition. In this example, the sizing agent 102 includes as its constituents: (1) a backing materials component; (2) an intermediate materials component; and (3) a surface materials component. In this example, each of these components is of different material composition from the others. More particularly, the backing materials component (of sizing agent 102) includes materials of the following weights: 80 portions of 25° Bé magnesium sulfate solution; 100 portions of 85% light calcined magnesia; 90 portions of calcium carbonate heavy; 10 portions of kaoline; 30 portions of lightweight perlite; 0.2 portion of tartrate; 0.3 portion of polycarboxylate superplasticizer; and 5 portions of styrene-butadiene emulsion. The intermediate materials component (of sizing agent 102) includes materials of the following weights: 240 portions of 25° Bé magnesium sulfate solution; 300 portions of 85% light calcined magnesia; 100 portions of calcium carbonate heavy; 60 portions of saw powder; 30 portions of lightweight perlite; 0.6 portion of tartrate; 1 portion of polycarboxylate superplasticizer; and 9 portions of styrene-butadiene emulsion. The surface materials component (of sizing agent 102) includes materials of the following weights: 120 portions of 25° Bé magnesium sulfate solution; 150 portions of 85% light calcined magnesia; 50 portions of calcium carbonate heavy; 30 portions of saw powder; 0.3 portion of tartrate; 0.5 portion of polycarboxylate superplasticizer; and 5 portions of styrene-butadiene emulsion.

In this example, the following process was employed to produce a high-strength, water-resistant, fire-proof MOS plate 100.

Prepare the backing materials component of the sizing agent 102. Take 80 portions of water-adjusted 25° Bé magnesium sulfate solution and orderly add 0.2 portion of tartaric acid and 0.3 portion of polycarboxylate superplasticizer and then evenly stir for 2 minutes. Then, orderly add 100 portions of 85% light calcined magnesia, 90 portions of calcium carbonate heavy, and 10 portions of kaoline and stir for 2 minutes. Then, add 30 portions of lightweight perlite and stir for 2 minutes. Then, add 5 portions of styrene-butadiene emulsion and stir for 5 minutes.

Prepare the intermediate materials component of the sizing agent 102. Take 240 portions of water-adjusted 25° Bé magnesium sulfate solution and orderly add 0.6 portion of tartaric acid and 1 portion of polycarboxylate superplasticizer and then evenly stir for 2 minutes. Then, orderly add 300 portions of 85% light calcined magnesia, 100 portions of calcium carbonate heavy, 60 portions of saw powder, and 30 portions of lightweight perlite and stir for 2 minutes. Then, add 9 portions of styrene-butadiene emulsion and stir for 5 minutes.

Prepare the surface materials component of the sizing agent 102. Take 120 portions of water-adjusted 25° Bé magnesium sulfate solution and orderly add 0.3 portion of tartaric acid and 0.5 portion of polycarboxylate superplasticizer and then evenly stir for 2 minutes. Then, orderly add 150 portions of 85% light calcined magnesia, 50 portions of calcium carbonate heavy, and 30 portions of saw powder and stir for 2 minutes. Then, add 5 portions of styrene-butadiene emulsion and stir for 5 minutes.

One at a time, pour the prepared sizing agent 102 components in the die 200. First, dispose the backing materials component within the die 200 and make it even (e.g., let it settle/level) within the die 200. Then, add at least a first fibrous layer 104 over the backing materials component within the die 200. Then, dispose the intermediate materials component within the die 200 over the at least a first fibrous layer 104 and make it even (e.g., let it settle/level) within the die 200. Then, add at least a second fibrous layer 104 over the intermediate materials component within the die 200. Then, dispose the surface materials component within the die 200 over the at least a second fibrous layer 104 and make it even (e.g., let it settle/level) within the die 200.

Dispose the die 200, along with its contents, in a ventilated environment conducive to curing. In accordance with some embodiments, the die 200 and its contents may be exposed to a temperature in the range of about 15-35° C. (e.g., about 15-20° C., about 20-25° C., about 25-30° C., about 30-35° C., or any other sub-range in the range of about 15-35° C.). After curing for about 12 hours or more, remove (e.g., knock out) the MOS plate 100 from the die 200. Then, dispose the MOS plate 100 in a ventilated environment conducive to curing for about 4-6 days.

Of course, as will be appreciated in light of this disclosure, additional or fewer fibrous layers 104 may be utilized, in accordance with some other embodiments. As will be further appreciated, the relative quantities of each of the first, second, and third components of sizing agent 102 may be customized, as desired for a given target application or end-use. As will be further appreciated, the stirring times are not intended to be limited only to the example durations provided.

The example MOS plate 100 made in accordance with the details of Example 3, described above, exhibited the attributes summarized below in Table 3:

TABLE 3

| | |
|---|---|
| Breaking Strength: | >13 MPa |
| Compressive Strength: | >25 MPa |
| Nail-Holding Ability: | >60N |
| Softening Coefficient: | >0.95 |
| Non-Inflammability: | Grade A |
| Water-Resistance: | Good |
| Other: | No metal corrosion, scumming, or absorption |
| | of moisture causing halogenide formation |

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

What is claimed is:

1. A magnesium oxysulfate plate comprising:
a sizing agent;
a first fibrous layer disposed at a first location within the sizing agent; and
a second fibrous layer disposed at a second location within the sizing agent, wherein the first location and the second location are not immediately adjacent one another.

2. The plate of claim 1, wherein:
the sizing agent comprises:
a backing materials component;
an intermediate materials component adjacent to the backing materials component; and
a surface materials component adjacent to the intermediate materials component; and
at least one of:
the first fibrous layer is disposed between the backing materials component and the intermediate materials component; and
the second fibrous layer is disposed between the intermediate materials component and the surface materials component.

3. The plate of claim 2, wherein the backing materials component, the intermediate materials component, and the surface materials component are each of the same material composition.

4. The plate of claim 2, wherein the backing materials component, the intermediate materials component, and the surface materials component each comprise:
240 portions of 25° Bé magnesium sulfate solution;
300 portions of 85% light calcined magnesia;
90 portions of coal ash;
60 portions of saw powder;
30 portions of lightweight perlite;
1 portion of tartrate;
1 portion of polycarboxylate superplasticizer; and
9 portions of styrene-butadiene emulsion.

5. The plate of claim 2, wherein the backing materials component, the intermediate materials component, and the surface materials component are each of different material composition.

6. The plate of claim 2, wherein at least one of:
the backing materials component comprises:
80 portions of 25° Bé magnesium sulfate solution;
100 portions of 85% light calcined magnesia;
90 portions of coal ash;
10 portions of kaoline;
30 portions of lightweight perlite;
0.2 portions of tartrate;
0.3 portions of polycarboxylate superplasticizer; and
5 portions of styrene-butadiene emulsion;
the intermediate materials component comprises:
240 portions of 25° Bé magnesium sulfate solution;
300 portions of 85% light calcined magnesia;
100 portions of coal ash;
60 portions of saw powder;
30 portions of lightweight perlite;
0.6 portions of tartrate;
1 portion of polycarboxylate superplasticizer; and
9 portions of styrene-butadiene emulsion; and
the surface materials component comprises:
120 portions of 25° Bé magnesium sulfate solution;
150 portions of 85% light calcined magnesia;
50 portions of coal ash;
30 portions of saw powder;
0.3 portions of tartrate;
0.5 portions of polycarboxylate superplasticizer; and
5 portions of styrene-butadiene emulsion.

7. The plate of claim 2, wherein at least one of:
the backing materials component comprises:
80 portions of 25° Bé magnesium sulfate solution;
100 portions of 85% light calcined magnesia;
90 portions of calcium carbonate heavy;
10 portions of kaoline;
30 portions of lightweight perlite;
0.2 portions of tartrate;
0.3 portions of polycarboxylate superplasticizer; and
5 portions of styrene-butadiene emulsion;
the intermediate materials component comprises:
240 portions of 25° Bé magnesium sulfate solution;
300 portions of 85% light calcined magnesia;
100 portions of calcium carbonate heavy;
60 portions of saw powder;
30 portions of lightweight perlite;
0.6 portions of tartrate;
1 portion of polycarboxylate superplasticizer; and
9 portions of styrene-butadiene emulsion; and
the surface materials component comprises:
120 portions of 25° Bé magnesium sulfate solution;
150 portions of 85% light calcined magnesia;
50 portions of calcium carbonate heavy;
30 portions of saw powder;
0.3 portions of tartrate;
0.5 portions of polycarboxylate superplasticizer; and
5 portions of styrene-butadiene emulsion.

8. The plate of claim 2, wherein at least one of the backing materials component, the intermediate materials component, and the surface materials component comprises:
80-240 portions of 23-28° Bé magnesium sulfate solution;
100-300 portions of 85% light calcined magnesia;
0.1-5 portions of tartrate;
2-10 portions of a styrene-butadiene emulsion;
0-100 portions of a heavyweight filler;
0-100 portions of a lightweight filler; and
0.1-5 portions of a water-reducing agent.

9. A method of forming a magnesium oxysulfate plate, the method comprising:
preparing a sizing agent;
disposing the sizing agent within a die;
disposing a plurality of fibrous layers within the sizing agent; and
curing the sizing agent with the plurality of fibrous layers disposed therein to produce the magnesium oxysulfate plate.

10. The method of claim 9, wherein preparing the sizing agent comprises:
providing 80-240 portions of a magnesium sulfate solution having a density of about 23-28° Bé;
adding tartrate, a styrene-butadiene emulsion, and a water-reducing agent to the magnesium sulfate solution;
adding 85% light calcined magnesia and a heavyweight filler to the resultant mixture; and
adding a lightweight filler to the resultant mixture.

11. The method of claim 10, wherein at least one of:
the tartrate, the styrene-butadiene emulsion, and the water-reducing agent are added in the following weights:
about 0.1-5 portions tartrate;
about 2-10 portions styrene-butadiene emulsion; and
about 0.1-5 portions of water-reducing agent; and
the 85% light calcined magnesia, the heavyweight filler, and the lightweight filler are added in the following weights:
100-300 portions of the 85% light calcined magnesia;
0-100 portion(s) of the heavyweight filler; and
0-100 portion(s) of the lightweight filler.

12. The method of claim 9, wherein disposing the sizing agent within the die comprises:
disposing a first quantity of the sizing agent within the die;
disposing a second quantity of the sizing agent over the first quantity of the sizing agent within the die; and
disposing a third quantity of the sizing agent over the second quantity of the sizing agent within the die.

13. The method of claim 12, wherein disposing the plurality of fibrous layers within the sizing agent comprises:
disposing at least one fibrous layer over the first quantity of the sizing agent prior to disposing the second quantity of the sizing agent over the first quantity of the sizing agent; and
disposing at least one fibrous layer over the second quantity of the sizing agent prior to disposing the third quantity of the sizing agent over the second quantity of the sizing agent.

14. The method of claim 9, wherein:
the sizing agent comprises:
a backing materials component;
an intermediate materials component; and
a surface materials component; and
disposing the sizing agent within the die comprises:
first disposing the backing materials component within the die;
then disposing the intermediate materials component over the backing materials component within the die; and
then disposing the surface materials component over the intermediate materials component within the die.

15. The method of claim 14, wherein disposing the plurality of fibrous layers within the sizing agent comprises:
disposing at least one fibrous layer over the backing materials component prior to disposing the intermediate materials component over the backing materials component; and
disposing at least one fibrous layer over the intermediate materials component prior to disposing the surface materials component over the intermediate materials component.

16. The method of claim 9, wherein curing the sizing agent with the plurality of fibrous layers disposed therein comprises:
exposing the sizing agent to an environment having a temperature in the range of about 15-35° C. for about 12 hours or greater.

17. A structural insulated panel comprising:
a first magnesium oxysulfate plate;
a second magnesium oxysulfate plate disposed adjacent the first magnesium oxysulfate plate; and
an insulating layer disposed between the first magnesium oxysulfate plate and the second magnesium oxysulfate plate.

18. The panel of claim 17, wherein at least one of the first magnesium oxysulfate plate and the second magnesium oxysulfate plate comprises:
a sizing agent of homogeneous material composition; and
a plurality of fibrous layers disposed within the sizing agent.

19. The panel of claim 17, wherein at least one of the first magnesium oxysulfate plate and the second magnesium oxysulfate plate comprises:
a sizing agent of heterogeneous material composition; and
a plurality of fibrous layers disposed within the sizing agent.

20. The panel of claim 17, wherein at least one of the first magnesium oxysulfate plate and the second magnesium oxysulfate plate has a chamfered edge.
